(19) United States
(12) Patent Application Publication
(10) Pub. No.: US 2024/0070246 A1
(43) Pub. Date: Feb. 29, 2024

(54) SECURITY SYSTEM AND METHOD FOR CONTROLLING ACCESS TO SERVER AND EXECUTION OF INSTRUCTION THROUGH FACIAL RECOGNITION OF SERVER USER

(71) Applicant: PNPSECURE INC., Seoul (KR)

(72) Inventors: Chunoh PARK, Gyeonggi-do (KR); Seontae JIN, Gyeonggi-do (KR); Jiwung JEON, Gyeonggi-do (KR)

(21) Appl. No.: 18/238,285

(22) Filed: Aug. 25, 2023

(30) Foreign Application Priority Data
Aug. 31, 2022 (KR) 10-2022-0109811

(51) Int. Cl. G06F 21/32; G06F 21/62; G06V 40/16

(52) U.S. Cl. CPC G06F 21/32; G06F 21/6218; G06V 40/172; G06F 2221/2141

(57) ABSTRACT

A security system and method for controlling server access and command execution through the facial recognition of a server user, where the security system includes: a secure access agent including a face recognition module configured to repeatedly collect and transmit the facial information of a user, and a notification module configured to output a situation of data communication with a security target server; and a security proxy server including a user information storage module configured to store user information, a security policy storage module configured to store security policies, a relay module configured to relay data communication, and a security processing module configured to check whether the facial image of the facial information received from the face recognition module matches the facial image of the user information and to control the relay module to block access to the security target server or block only designated data communication.

### CROSS-REFERENCE

This application claims the benefit of Korean Patent Application No. 10-2022-0109811 filed on Aug. 31 2022, which is hereby incorporated by reference herein in its entirety.

### BACKGROUND

The present invention relates to a security system and method that identify an actual user by reflecting the results of user face recognition therein and control the server access and command execution of an unauthorized user.

For server access and command execution, biometric technology has been developed to check the authority of users who have attempted access and execution. As is well known, biometric technology is a technology that extracts physical and/or behavioral characteristics of a person (a user) and verifies the identity of the person, and has been already widely used in the field of security technology. Biometric recognition may be classified into fingerprint recognition, iris scanning, retina scanning, hand geometry, and facial recognition according to the biometric target. Among them, the facial recognition, which can automatically recognize a bodily part of a user and perform a procedure without requiring the user to perform a specific action, has been widely used for biometric recognition.

However, in the conventional facial recognition technology for server access and command execution, a security procedure is performed only upon initial access. After a user has been authenticated, another user without authority may enter an abnormal command to a security target server by manipulating a terminal, accessing the security target server, without permission. Furthermore, when a terminal is infected with malicious code, another user can remotely control the terminal online and enter an abnormal command to the security target server.

In addition, conventionally, a user authentication process using face recognition technology is performed in a terminal. Accordingly, when the authentication process of a terminal having relatively weak security is infected with malicious code, a security function through facial recognition may become useless. A security target server may also be exposed to risk, and thus its safety cannot be guaranteed.

Furthermore, in the case where a security function is performed in a terminal, when unauthorized access is checked, the screen of the terminal itself is blocked or the operation of the terminal is stopped, so that there is the irrationality of interfering with the operation of an application other than a security target.

Prior art document 1: Korean Patent Application Publication No. 10-2021-0004319 (published on Jan. 13, 2021)

### SUMMARY OF THE INVENTION

The present invention has been conceived to overcome the above-described problems, and an object of the present invention is to provide a security system and method for controlling server access and command execution through the facial recognition of a server user that can improve security without impairing convenience through the combination of facial recognition technology and access and authority control technology and can block a server access-related task through the checking of whether an unauthorized person is using access even when a server has been already accessed by an authorized user.

In order to accomplish the above object, the present invention provides a security system for controlling server access and command execution through the facial recognition of a server user, the security system being equipped with a security proxy server that relays and secures data communication between a computer terminal and a security target server, the security system including: a secure access agent including a face recognition module configured to repeatedly collect and transmit the facial information of a user who is permitted to access the security target server and is accessing the security target server at a designated time point or in a designated situation, and a notification module configured to output a situation of data communication with the security target server, and installed on the terminal and configured to be executed based on the operating system (OS) of the terminal; and the security proxy server including a user information storage module configured to store user information, a security policy storage module configured to store security policies for each user, a relay module configured to relay data communication between the secure access agent and the security target server, and a security processing module configured to check whether the facial image of the facial information received from the face recognition module matches the facial image of the user information through the comparison between them and to control the relay module to block access to the security target server or block only designated data communication according to security policies corresponding to the user information, wherein the user information storage module, the security policy storage module, the relay module, and the security processing module are installed to be executed based on a server OS.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram schematically showing the communication structure of a security system according to the present invention;

FIG. 2 is a block diagram showing the configuration of the security system according to the present invention;

FIG. 3 is an image showing an embodiment of an input window in which a security target server is set in the security system according to the present invention;

FIG. 4 is an image showing an embodiment of an input window in which a user permitted to access a security target server is set in the security system according to the present invention;

FIG. 5 is an image showing an embodiment of a list of log data related to the security history that has been handled by the security system according to the present invention;

FIG. 6 is a flowchart sequentially showing a security method based on a security system according to the present invention;

FIGS. 7A and 7B is a diagram schematically showing an example of a permitted task of a user in a security system according to the present invention;

FIGS. 8A, 8B and 8C is a diagram schematically showing an example of an unpermitted task of a user in a security system according to the present invention; and

FIGS. 9A, 9B and 9C is an image showing an embodiment of the security process of a security system according to the present invention.

### DETAILED DESCRIPTION OF THE INVENTION

The terms used in the conjunction with embodiments have been selected from general terms, which are currently widely used, as much as possible while considering the functions of corresponding components in the present invention, but they may vary depending on the intention of a person skilled in the art, a precedent, the emergence of new technology, and/or the like. Furthermore, in a specific case, there may also be a term selected by the applicant as desired, in which case the meaning thereof will be described in detail in the description of the invention. Accordingly, the terms used herein should be defined based on the meanings of the terms and the overall context of the present specification, not simply based on the names of the terms.

Throughout the present specification, when a part is described as “including” a component, it means that the part may further include one or more other components, not excluding one or more other components, unless otherwise stated. Furthermore, the term “unit,” “module,” or the like refers to a unit in which at least one function or operation is processed. This may be implemented as hardware or software, or may be implemented as a combination of hardware and software.

Embodiments of the present invention will be described in detail below with reference to the accompanying drawings so that those skilled in the art can easily practice the present invention. However, the present invention may be implemented in many different forms and is not limited to the embodiments described herein.

Details of the present invention will be described below based on the accompanying drawings.

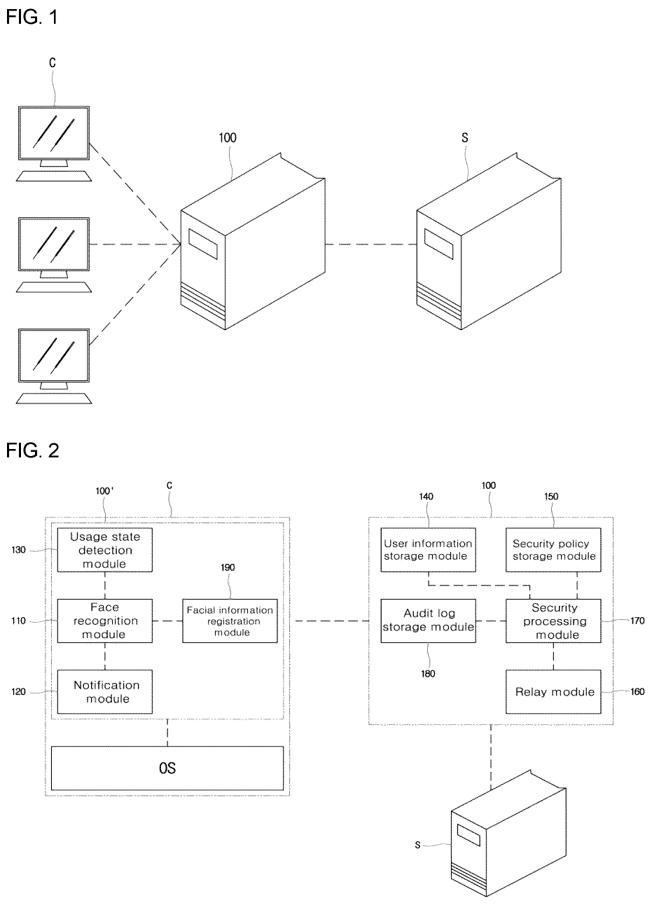

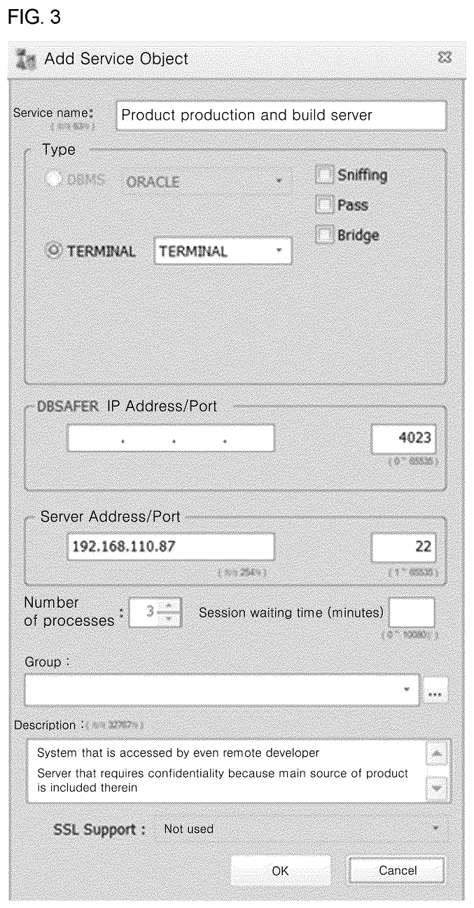

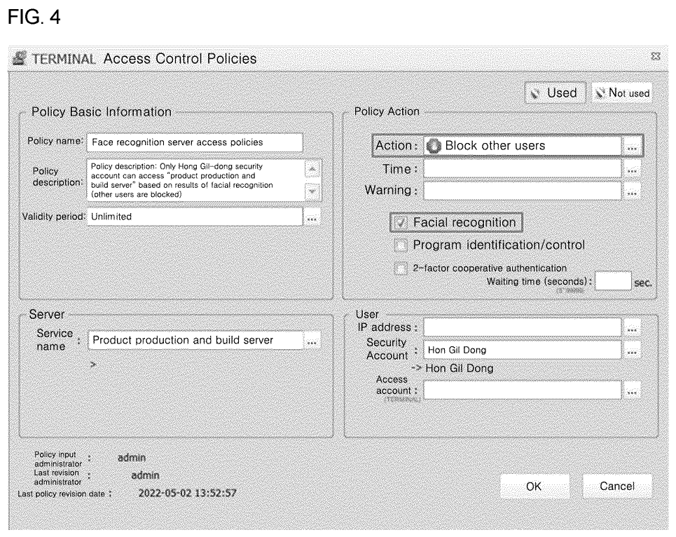

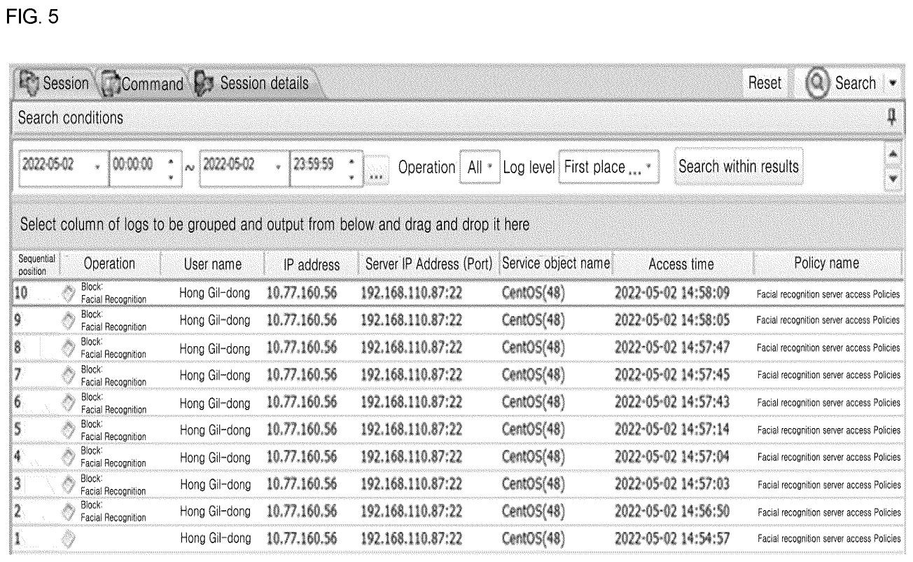

FIG. 1 is a diagram schematically showing the communication structure of a security system according to the present invention, FIG. 2 is a block diagram showing the configuration of the security system according to the present invention, FIG. 3 is an image showing an embodiment of an input window in which a security target server is set in the security system according to the present invention, FIG. 4 is an image showing an embodiment of an input window in which a user permitted to access a security target server is set in the security system according to the present invention, and FIG. 5 is an image showing an embodiment of a list of log data related to the security history that has been handled by the security system according to the present invention.

Referring to FIGS. 1 to 5, the security system according to the present invention is related to a security process that is performed in a security target server S in a communication system in which a terminal C accesses the security target server S through a security proxy server 100.

More specifically, the security system equipped with the security proxy server 100 that relays and secures data communication between the computer terminal C and the security target server S includes: a secure access agent 100′ including a face recognition module 110 configured to repeatedly collect and transmit the facial information of a user who is permitted to access the security target server S and is accessing the security target server S at a designated time point or in a designated situation, and a notification module 120 configured to output a situation of data communication with the security target server S, and installed on the terminal C; and the security proxy server 100 including a user information storage module 140 configured to store user information, a security policy storage module 150 configured to store security policies for each user, a relay module 160 configured to relay data communication between the secure access agent 100′ and the security target server S, and a security processing module 170 configured to check whether the facial image of the facial information received from the face recognition module 110 matches the facial image of the user information and to control the relay module 160 to block access to the security target server S or control the communication of a specified value according to security policies for the user information corresponding to the facial information.

Furthermore, in the security system according to the present invention, the secure access agent 100′ further includes a usage state detection module 130 configured to detect a change in the state of the user who is permitted to access the security target server S and is accessing the security target server S and to transfer a signal so that the face recognition module 110 collects the facial information of the user. The usage state detection module 130 may transmit a signal so that the face recognition module 110 collects the facial information of the user when a command input in the state of being connected because access to the security target server S is permitted is a command out of authority.

For reference, the facial image is an image acquired by photographing the face of the user without change, and functions to convert the unique face shape of a user into a unique code by vectorizing it using a known face recognition algorithm. The unique code is face vector information, is stored in the security environment of the terminal C, and is transmitted to the security proxy server 100 as a component of facial information.

Each of the components will be described below:

The secure access agent 100′ according to the present invention is an application installed on the user terminal C to perform a security function, and is executed based on the OS of the terminal C to perform self-execution and access to an external communication network.

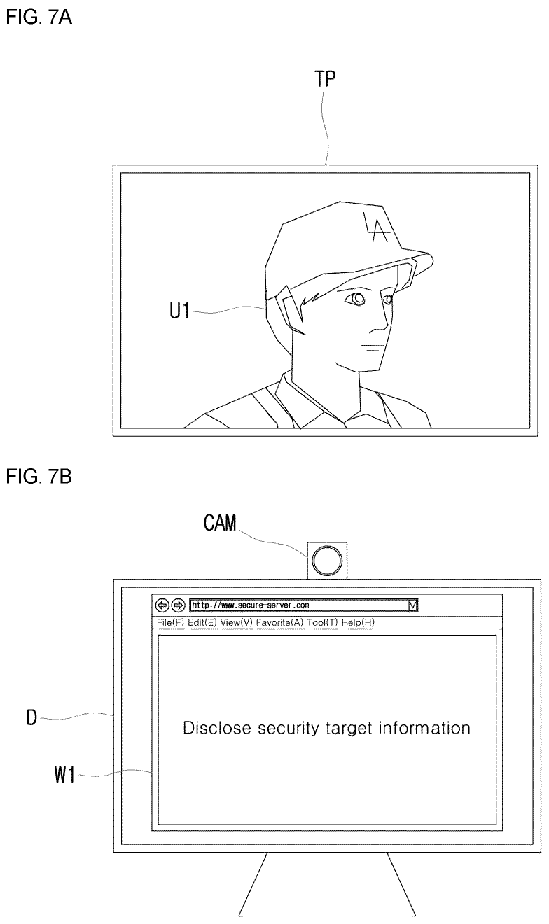

The face recognition module 110 configured in the secure access agent 100′ is a part programmed to perform a face recognition function in the secure access agent 100′, which is an application for a security function, and is processed in connection with related hardware. The face recognition module 110 collects a facial image of a current user by using a photographing means (CAM; see FIG. 7B), such as a camera, installed in the terminal C. The collection of a facial image by the facial recognition module 110 is performed upon user login, and a facial image is also repeatedly collected at every designated time point or in every designated situation. When a facial image composed of an image acquired by photographing the face of a user and a unique code is collected, the facial recognition module 110 attaches the identify (ID) of the user to the facial image, sets them as facial information, and transmits the facial information to a designated Internet Protocol (IP) address through the OS. In this case, the designated IP address is the IP address of the security proxy server 100.

The security system according to the present invention collects a facial image corresponding to the ID at least once through the facial information registration module 190 of the secure access agent 100′, and needs to register and manage the facial image by transferring it to the user information storage module 140 of the security proxy server 100. This is an operation necessary to construct the facial image and user information mapping the facial information together in the security proxy server 100. In the present embodiment, the facial information is composed of the photographed image, the unique code, and the ID. Alternatively, the facial information may be composed of only the unique code and the ID.

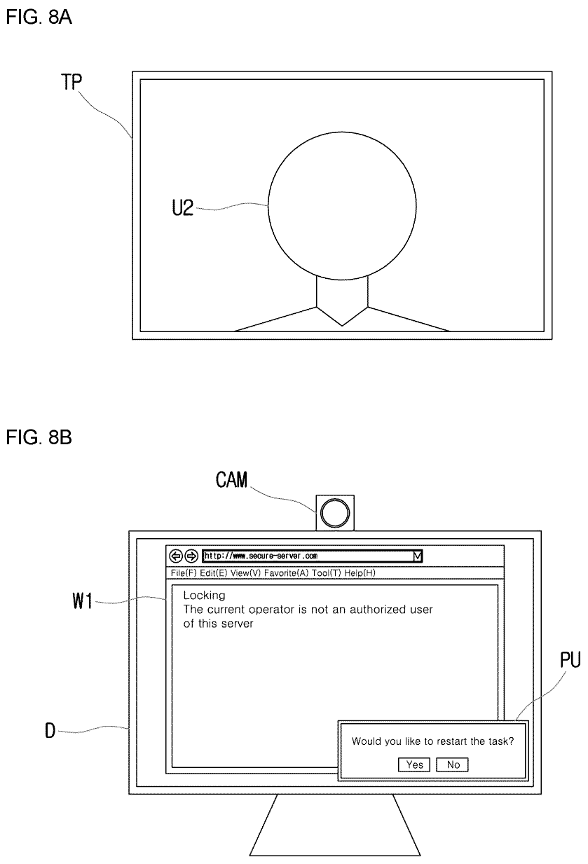

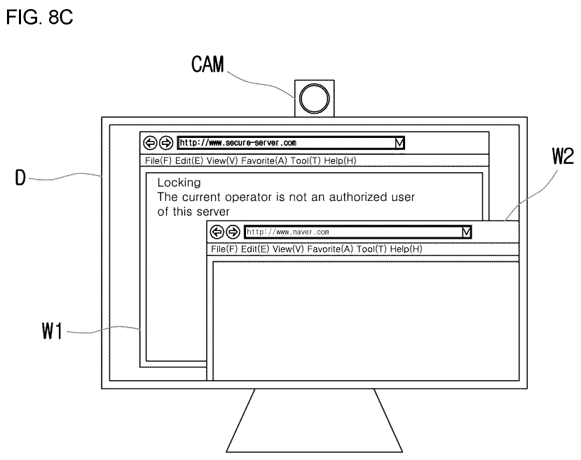

The notification module 120 is a part programmed to perform an information output function in the secure access agent 100′, which is an application for a security function, and is processed in connection with related hardware. The notification module 120 outputs a situation of data communication with the security target server S. In this case, the situation of data communication is whether the secure connection agent 100′ has accessed the security target server S, and a method of providing guidance on whether the access has been made may be various. For example, when the access of the secure access agent 100′ to the security target server S is blocked, the notification module 120 may simply display only a warning window regarding restriction on data communication in the form of a speech balloon according to a preset process, may forcibly terminate (lock) the screen D (see FIG. 7B) of the terminal C, may forcibly terminate a task window (a web page) of the web browser for the security target server S, or may forcibly terminate a task window of a word processor, which is an application that executes a data file received from the security target server S. Furthermore, a task window of the web browser or application may be maintained without termination, but the movement of a mouse cursor, text input, or other functional operations in the task window may be restricted. Moreover, the notification module 120 may guide a user to a subsequent procedure for self-verification by displaying a separate independent pop-up window (PU; see FIG. 8B) after the above-described task window control.

The usage state detection module 130 is a part programmed to perform a user recognition function in the secure access agent 100′, which is an application for a security function, and is processed in connection with related hardware. The usage state detection module 130 detects a change in the state of a user who is permitted to access the security target server S and is accessing the security target server S, and transfers a signal so that the face recognition module 110 collects the facial information of the user. As described above, the face recognition module 110 repeatedly collects the facial information of the user at every designated time point or in every designated situation. In this case, the designated time point is a predetermined time interval or a specific time point designated by an administrator or the user. Furthermore, the designated situation relates to a change in the state of the user, and may be one or more of various types of changes such as a change in the posture of the user, the departure of the user from the photographing range of the photographing means CAM, the detection of the facial images of two or more people within the photographing range, a change in the image of the worn clothes or accessories of the user, etc.

Furthermore, the usage state detection module 130 may detect a case where a command entered in the state of being connected because access to the security target server S is permitted is a command out of authority, and may transmit a signal so that the face recognition module 110 collects the facial information of the user.

As is known, an OS-based terminal generates task traffic (session information) during execution, and thus the command is determined by analyzing task traffic information. Accordingly, the usage state detection module 130 or the security processing module 170 determines the command by analyzing the task traffic information generated during a task related to the security target server S, and may determine whether the command is a command out of authority by performing a comparison with the security policies stored in the security policy storage module 150.

In the present embodiment, the command out of authority is a specific command issued beyond the range of business of the user, i.e., a command to access an area inaccessible to the user in the security target server S, a command to check and copy Internet authentication information, a command to leak personal information, a command to install an unauthenticated application, and a command to perform online banking out of the range of business of the user. Furthermore, the specific command may be related to a forbidden word, a command subject to intensive monitoring, a command subject to payment, and the like. Furthermore, the command out of authority may be various, and various modifications may be implemented within the range that does not depart from the scope of the attached claims. The analysis of task traffic information for the determination of a command may be directly performed by the usage state detection module 130. Alternatively, when the face recognition module 110 transmits facial information, it may also transmit task traffic information to the security proxy server 100 without the above-described analysis.

The security proxy server 100 is a gateway for accessing the security target server S, so that the terminal C attempting to access the security target server S needs to perform data communication with the security proxy server 100. Furthermore, a user face recognition analysis and authentication process is performed in the security proxy server 100, not in the terminal C itself, so that security performance through facial recognition can be considerably increased. Furthermore, the security proxy server 100 is intended for the security of the security target server S. Accordingly, the security proxy server 100 blocks only a process of communication with the security target server S in the terminal C or blocks only the execution of a specific application for reading a data file received from the security target server S, but is not involved in Internet access and application operation control unrelated to the security target server S. Therefore, as shown in FIG. 8B, a web page W2 of the server and a task window of the application unrelated to the security target server S are kept executed without the control of the security proxy server 1000.

This Will be Described in More Detail Below:

The security proxy server 100 includes the user information storage module 140 and the security policy storage module 150, which are a combination of hardware for a data storage function and a storage application, and the relay module 160 and the security processing module 170, which are a combination of hardware for a data communication relay function and a communication application. Furthermore, the security proxy server 100 may further include an audit log storage module 180, which is a combination of hardware for a data storage function and a storage application for recording the history of the execution of the security processing module 170. The user information storage module 140, the security policy storage module 150, the relay module 160, and the security processing module 170 are executed based on the operating system (OS) of the security proxy server 100.

The user information storage module 140 is programmed to perform a data storage function in the security proxy server 100 having a data communication relay function, and is processed in connection with related hardware. The user information storage module 140 stores user information. The user information includes the personal information and ID of the user. Accordingly, information about a login procedure for verifying the identity of the user is retrieved from the user information storage module 140. When the user registers in the security proxy server 100 regardless of whether access to the security target server S is permitted, the user information of the corresponding user may be stored in the user information storage module 140, or only the user information of a user permitted to access the security target server S may be stored in the user information storage module 140. In the present embodiment, the user information storage module 140 stores only the user information of a user whose access is permitted, but is not limited to the present embodiment as long as it does not depart from the scope of the attached claims.

The security policy storage module 150 is programmed to perform a data storage function in the security proxy server 100 having a data communication relay function, and is processed in connection with related hardware. The security policy storage module 150 stores security policies for each user. The security policies relate to the range of access permitted to the corresponding registered user. When user registration is not performed, access to the security target server S is unconditionally blocked regardless of who the user is. Furthermore, the security policy storage module 150 stores a security policy for each command. Accordingly, when a command out of authority is entered to the terminal, the security processing module 170 blocks data communication between the terminal C and the security target server S or blocks the execution of the command out of authority according to a security policy for the command. In the present embodiment, according to the security policies stored in the security policy storage module 150, the permitted range of access to the security target server S varies depending on the security level and a security level is designated for each user, so that the management of security policies becomes systematic and efficient. In the present embodiment, an administrator registers the IP address of the security target server S and sets security options to monitor Telnet/SSH services, as shown in FIG. 3. In addition, as shown in FIG. 4, the administrator registers the user information of a user who is permitted to access the security target server S, and designates the range of access of the corresponding user. Since the image of an input window shown in FIGS. 3 and 4 is an example, a method for setting security policies may be variously modified within the range that does not depart from the scope of the attached claims.

The relay module 160 is programmed to perform a data communication relay function in the security proxy server 100 having a data communication relay function, and is processed in connection with related hardware. The relay module 160 relays data communication between the secure access agent 100′ and the security target server S. The relay module 160 controls data communication under the control of the security processing module 170.

The security processing module 170 is programmed to perform a data security function in the security proxy server 100 having a data communication relay function, and is processed in connection with related hardware. The security processing module 170 determines whether there is a match by comparing the facial image of the facial information received from the face recognition module 110 with the facial image of the user information, and controls the relay module 160 to collectively block access to the security target server S or control only designated data communication according to security policies corresponding to the user information. As described above, the security processing module 170 continuously determines whether the current user is an authorized user by comparing the facial information repeatedly collected during the task of the user with the facial image of the user information, and performs control to block the access of the terminal C to the security target server S or block only designated data communication according to security policies for the corresponding user in case of emergency. For reference, although an ID is configured in the facial information in the present embodiment, the ID may not be configured in the facial information due to an unexpected reason. In this case, the security processing module 170 queries the secure access agent 100′ for the identification ID of the facial information, and the face recognition module 110 retrieves the ID from the facial information registration module 190 and transmits it. Furthermore, the security processing module 170 determines a command by analyzing tack traffic information, retrieves security policies corresponding to the command from the security policy storage module 150, and controls the relay module 160 to collectively block access to the security target server S or control only designated data communication according to the security policies.

The process of the security processing module 170 will be described again below.

The security proxy server 100 further includes the audit log storage module 180 configured to block the data communication between the security target server S and the terminal C through the security processing module 170 or to, when the command determined through the analysis of task traffic information is a command out of authority, block the data communication or record and store a case where the execution of a command out of authority is blocked as log data. Accordingly, the administrator checks the log data stored in the audit log storage module 180 and updates the secure access agent 100′ and the security proxy server 100. Although in the present embodiment, log data is generated and stored in the audit log storage module 180 when data communication between the security target server S and the terminal C and command execution are blocked, the details of the execution of the security processing module 170 may be recorded as log data regardless of whether data communication and command execution are blocked.

For reference, the log data stored in the audit log storage module 180 may be output in the form of a list by the administrator, as shown in FIG. 5, and the user may check the security history recorded in the log data and update the security system according to the present invention by.

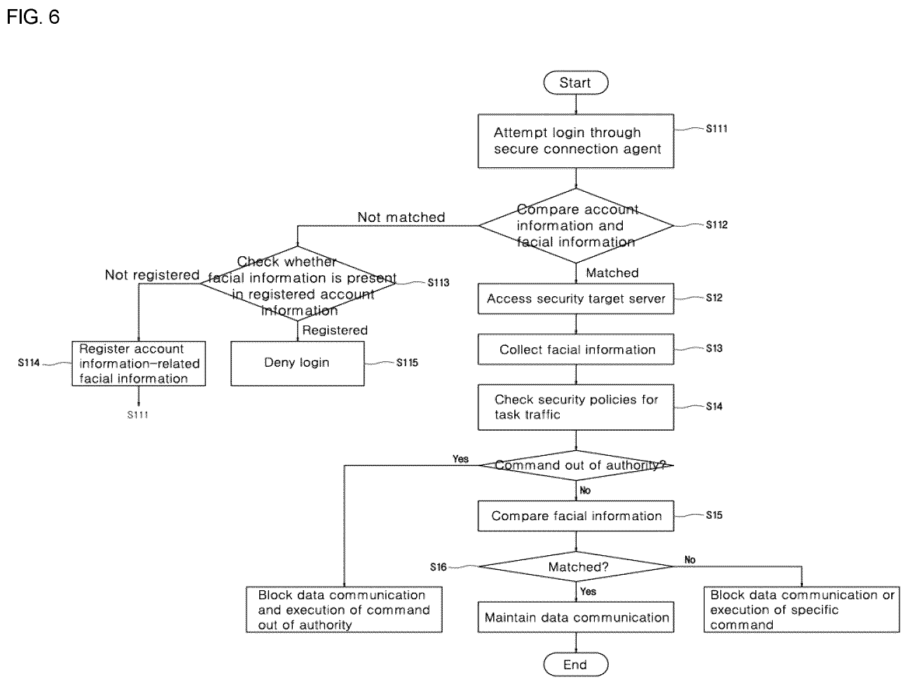

FIG. 6 is a flowchart sequentially showing a security method based on a security system according to the present invention, FIGS. 7A and 7B is a diagram schematically showing an example of a permitted task of a user in a security system according to the present invention, and FIGS. 8A, 8B and 8C is a diagram schematically showing an example of an unpermitted task of a user in a security system according to the present invention.

Referring to FIGS. 2 to 9, the security method according to the present invention is performed based on the security system.

S111: Step of Attempting Login Through Secure Access Agent

In the security system according to the present invention, the face recognition module 110 checks the face of a user attempting to access the security target server S and executes a login procedure.

Generally, in the login procedure, the entry of account information such as the ID and password PW of a user is basically performed, and a facial information checking process is performed as an additional checking process. In order to check the facial information of the user, the photographing means CAM generates a photographed image TP by photographing the face U1 of the user under the control of the face recognition module 110, the shape of the face U1 is extracted from the photographed image TP, and a unique code, which is face vector information, is generated through image analysis. Although the facial image may be composed of a photographed image TP of the face U1 of the user and a unique code, only the unique code may constitute the facial image. Thereafter, when the facial image is generated according to the above process, the face recognition module 110 generates facial information by setting the ID of the user and the facial image as a set. The face recognition module 110 transmits the facial information to the security proxy server 100, and the security processing module 170 of the security proxy server 100 performs a login procedure by comparing not only the ID and password PW of the user but also the facial information received from the face recognition module 110 with the user information and thus verifying the identity of the user.

S112: Step of Comparing Account Information and Facial Information

The security processing module 170 compares the account information and facial information entered by the user to the secure access agent 100′ with the account information and facial information of the user information stored in the user information storage module 140 of the security proxy server 100.

S113: Step of Checking Whether Facial Information is Present in Previously Registered Account Information

If as a result of the comparison, it is determined that there is a mismatch in facial information, the security processing module 170 checks whether the mismatch is caused by the absence of facial information registered as part of the user information or whether the entered facial information actually matches the facial information previously registered as part of the user information.

S114: Step of Registering Account Information-Related Facial Information

When it is determined that the reason for the mismatch in facial information is that facial information is not registered as part of the account information upon login, the facial information registration module 190 registers the facial information as part of the user information of the corresponding user, the user information storage module 114 is updated, and step S111 of the login attempt through the secure access agent is re-performed.

S115: Step of Denying Login

When the facial information of the user was already configured in the user information upon login attempt and it is determined that the reason for the mismatch in facial information is that the facial information configured in the user information and the facial information collected and generated by the face recognition module 110 upon login attempt do not match each other, the security processing module 170 blocks access to the security target server S. In addition, the notification module 120 of the secure access agent 100′ pops up a warning window to which the reason for the denial to login is posted so that the user can recognize it.

S12: Security Target Server Access Step

When the ID and password PW of the user are checked and it is determined that there is a match in facial information, the security processing module 170 controls the relay module 160 to enable data communication between the terminal C and the security target server S.

The security target server S may allow a web page W1 of a specific site to be output through a web browser configured in the terminal C, or may transmit a security target data file to the terminal C according to the user's selection so that the data file can be executed by a specific application installed on terminal C.

S13: Facial Information Collection Step

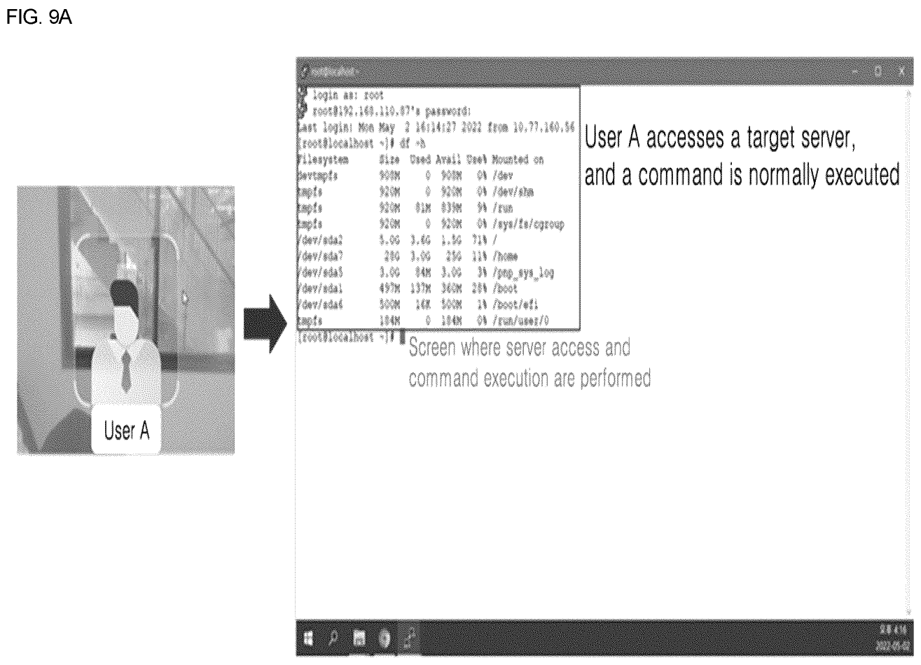

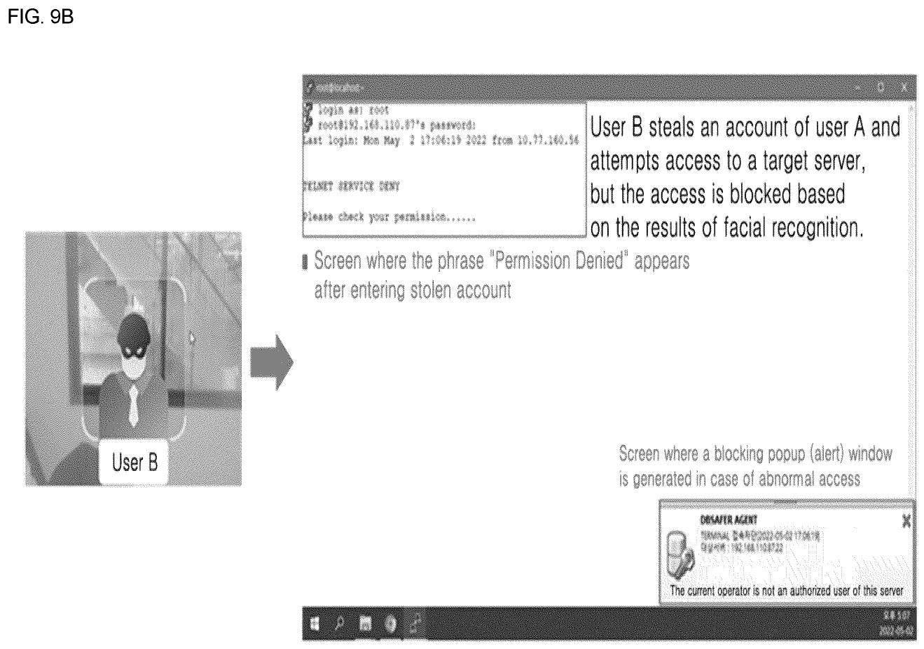

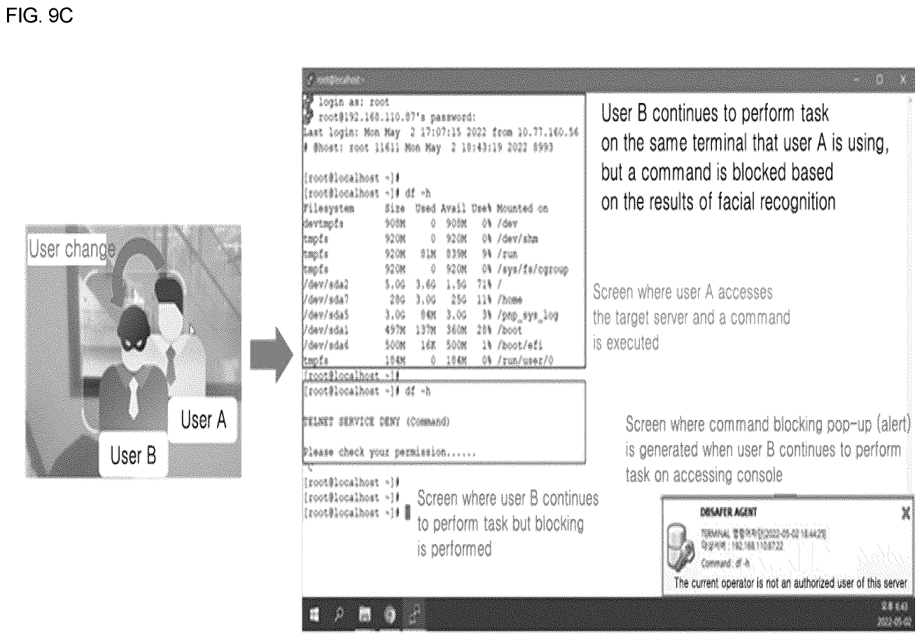

While a specific application is being executed for reading the data file or the web page W1 of the security target server S is being displayed after the access to the security target server S, the face recognition module 110 repeatedly controls the photographing means CAM to photograph the face U1, or U2 at every designated time point or in every designated situation, and generates a unique code, which is face vector information for the shape of the face U1 or U2, by analyzing the photographed image TP. Furthermore, the ID checked upon login and the unique code are set as a set and generate facial information. For reference, FIG. 9C shows a case where a user permitted to access the security target server S is changed to an unauthorized user after the login. The face recognition module 110 recognizes the above case as a designated situation and photographs the face U1 or U2 by controlling the photographing means CAM, as described above. Since the facial information generation and collection process is the same as the facial information generation and collection process performed upon the login, a detailed description thereof will be omitted.

The face recognition module 110 transmits the collected facial information to the security proxy server 100.

In addition, the face recognition module 110 may transmit task traffic information, generated in the process of working with the security target server S, together with the facial information. Alternatively, in addition to the transmission of the facial information by the face recognition module 110, the user state detection module 130 may transmit task traffic information to the security target server S. In this case, the user state detection module 130 may transmit task traffic information without analysis. However, the user state detection module 130 may check a command by analyzing task traffic information by itself, and may, when the command is a command out of authority, control the face recognition module 110 to collect the facial information of the user and then allow the facial information, together with the command, to be transmitted to the security proxy server 100.

S14: Task Traffic Security Policy Checking Step

The security processing module 170 having received the task traffic information or command together with the facial information checks the facial information and command or the facial information and task traffic information received from the secure access agent 100′, and retrieves security policies related to the corresponding command from the security policy storage module 150. When as a result of the retrieval, it is determined that the above-described command is a command out of authority according to the security policies, the relay module 160 is controlled to completely block or restrictively block access to the security target server S or to block only the execution of the command determined to be a command out of authority according to the security policies.

In contrast, when the command is not a command out of authority, the security processing module 170 continues a subsequent process to verify the facial information.

S15: Facial Information Comparison Step

The security processing module 170 retrieves the facial image of the user from the user information storage module 140 based on the ID of the facial information. The facial image of the corresponding user has been configured in the retrieved user information. The security processing module 170 checks whether the facial image of the facial information and the facial image of the user information match each other by comparing the facial image of the facial information with the facial image of the user information. As described above, since the facial image is composed of a unique code, which is facial vector information, it is determined through the comparison between unique codes whether the facial images match each other.

S16: Control Step

When as a result of the comparison between the facial image of the facial information and the facial image of the user information, it is determined that they match each other, as shown in FIGS. 7(a) and 9(a), data communication between the security target server S and the terminal C is maintained. However, when as a result of the comparison between the facial image of the facial information and the facial image of the user information, it is determined that they do not match each other, as shown in FIGS. 7(a) and 8(a), the security processing module 170 blocks data communication between the terminal C and the security target server S or blocks the execution of a specific command for the control of a task window according to a process such as that shown in FIG. 9B or 9(c).

In addition, the facial image of the user information is updated to the facial image of the facial information according to the setting of an administrator. Since the facial image of the facial information is the most recently collected image, it may be most similar to the facial image of facial information to be collected in the future. Accordingly, in order to minimize error in comparison between facial images, it is desirable to update the facial image of the existing user information to the recently collected facial image.

The present invention provides the effect of improving security without impairing convenience through the combination of facial recognition technology and access and authority control technology and the effect of blocking a server access-related task through the checking of whether an unauthorized person is using access even when a server has been already accessed by an authorized user.

Although the present invention has been described in detail with reference to the embodiments of the present invention, it can be appreciated by those skilled in the art or those having ordinary knowledge in the art that various modifications and changes may be made to the present invention without departing from the spirit and technical scope of the present invention described in the claims to be described later.

What is claimed is:

1. A security system for controlling server access and command execution through facial recognition of a server user, the security system being equipped with a security proxy server that relays and secures data communication between a computer terminal and a security target server, the security system comprising:
a secure access agent including a face recognition module configured to repeatedly collect and transmit facial information of a user who is permitted to access the security target server and is accessing the security target server at a designated time point or in a designated situation, and a notification module configured to output a situation of data communication with the security target server, and installed on the terminal and configured to be executed based on an operating system (OS) of the terminal; and
the security proxy server including a user information storage module configured to store user information, a security policy storage module configured to store security policies for each user, a relay module configured to relay data communication between the secure access agent and the security target server, and a security processing module configured to check whether a facial image of the facial information received from the face recognition module matches a facial image of the user information through a comparison between them and to control the relay module to collectively block access to the security target server or block only designated data communication according to security policies corresponding to the user information, wherein the user information storage module, the security policy storage module, the relay module, and the security processing module are installed to be executed based on a server OS.

2. The security system of claim 1, wherein the secure access agent further includes a usage state detection module configured to detect a change in a state of the user who is permitted to access the security target server and is accessing the security target server and to transfer a signal so that the face recognition module collects facial information of the user.

3. The security system of claim 1, wherein the secure access agent further includes a usage state detection module configured to transfer a signal so that the face recognition module collects facial information of the user when a command entered in a state of being connected because access to the security target server is permitted is a command out of authority.

4. The security system of claim 1, wherein:
the security proxy server relays data communication between a specific application installed on the terminal and the security target server and executes a security process; and
the notification module of the secure access agent outputs a situation of data communication of the specific application.

5. The security system of claim 1, wherein:
the security processing module transmits a notification signal when access to the security target server is collectively blocked or when only designated data communication is blocked; and
the notification module outputs guide data related to recollection of facial information in response to the notification signal.

6. The security system of claim 2, wherein:
the usage state detection module checks and transmits task traffic information associated with the security target server generated during an operation of the terminal after access to the security target server; and
the security processing module searches the security policy storage module for a command identified through an analysis of the task traffic information, and, when it is identified as a command out of authority, collectively blocks access to the security target server, blocks only designated data communication, or blocks an execution of the command out of authority according to a security policy for the command out of authority.

7. The security system of claim 2, wherein:
the usage state detection module identifies a command by analyzing task traffic information associated with the security target server generated during an operation of the terminal after access to the security target server, and transmits the command; and
the security processing module searches the security policy storage module for the command, and, when it is identified as a command out of authority, collectively blocks access to the security target server, blocks only designated data communication, or blocks an execution of the command out of authority according to a security policy for the command out of authority.

8. The security system of claim 6, wherein the security processing module first checks whether the command is a command out of authority before the comparison of the facial information of the user, and blocks data communication with the security target server or an execution of the command out of authority.

9. The security system of claim 1, wherein the security processing module updates the facial image of the user information, stored in the user information storage module, to the facial image of the facial information when it is determined that the facial image of the facial information received from the face recognition module matches the facial image of the user information.

10. The security system of claim 7, wherein the security processing module first checks whether the command is a command out of authority before the comparison of the facial information of the user, and blocks data communication with the security target server or an execution of the command out of authority.
